(19) United States
(12) Patent Application Publication
(10) Pub. No.: US 2021/0231275 A1
(43) Pub. Date: Jul. 29, 2021

(54) FLAME SIMULATING DEVICE AND ELECTRIC FIREPLACE

(71) Applicant: JIANGMEN KEYE ELECTRIC APPLIANCES MANUFACTURING CO., LTD, Jiangmen City (CN)

(72) Inventors: Xiangming He, Jiangmen City (CN); Guanglian Lin, Jiangmen City (CN)

(21) Appl. No.: 17/037,796

(22) Filed: Sep. 30, 2020

(30) Foreign Application Priority Data
Jan. 23, 2020 (CN) 202010076463.1

(51) Int. Cl. F21S 10/04; F24C 7/00

(52) U.S. Cl. CPC F21S 10/046; F24C 7/004

(57) ABSTRACT

Provided is a flame simulating device including a light source, a rotary light-transmitter, an imaging plate, a swing shelf and a driving component; the light source emits a first light group; the first light group is projected to the light-transmitter to form a second light group; the light source is disposed on the swing shelf, and the driving component drives the swing shelf to swing around the light-transmitter. An electric fireplace is also disclosed.

### CROSS-REFERENCE TO RELATED APPLICATIONS

This application claims priority to Chinese Application No. 202010076463.1, having a filing date of Jan. 23, 2020, the entire contents of which are hereby incorporated by reference.

### FIELD OF TECHNOLOGY

The following relates to the technical field of electric fireplaces, in particular to a flame simulating device which can simulate flickering flames and an electric fireplace installed with the flame simulating device.

### BACKGROUND

As decorative equipment which integrate modern optical principles, electric fireplaces have many outstanding decorative effects and are widely used. With electric energy as energy source, electric fireplaces provide no real flame but two-dimensional or three-dimensional simulated flames which are generated by reflection of lights, coupled with artificial charcoal to produce a visual effect of simulating flame combustion.

### SUMMARY

An aspect relates to flame simulating devices and electric fireplaces installed with any one of the above flame simulating devices.

In some embodiments, a flame simulating device includes a light source, a rotary light-transmitter, an imaging plate, a swing shelf and a driving component; the light source emits a first light group; the first light group is projected to the light-transmitter to form a second light group; the light source is disposed on the swing shelf, and the driving component drives the swing shelf to swing around the light-transmitter.

In some embodiments, the driving component includes a driving motor, the swing shelf includes a base shelf and a connecting bridge, and the light source is disposed on the base shelf; one end of the connecting bridge is fixed to the base shelf, and the other end is fixed to the driving shaft of the driving motor; the driving motor drives the base shelf to swing reciprocally around the light-transmitter via the connecting bridge.

In some embodiments, the driving component also includes a swing controller, and the swing controller controls the rotary mode of the driving motor.

In some embodiments, the base shelf is a strip plate which is parallel to the rotary axle of the light-transmitter.

In some embodiments, the light-transmitter is provided with a plurality of light-mixing blocks, and the first light group is projected into the light-transmitter and the light-mixing blocks thereof to form a second light group.

In some embodiments, the light-mixing block is a convex lens or a concave lens, or a combination of both.

In some embodiments, the light-transmitter includes at least two sub light-transmitting bodies connected through a connecting component, each sub light-transmitter is a rotary body formed by an arch arc. The light-mixing blocks are closely arranged along the circumferential direction of the light-transmitter to form a light-mixing block circle, and a number of light-mixing block circles are arranged along its axial direction.

In some embodiments, the sub light-transmitter is hollow, and the light-mixing block is disposed on its outer wall and/or an inner wall; alternatively, the light-transmitter is solid, and the light-mixing block is disposed on its outer surface.

In some embodiments, a motor is also included, and the motor drives the light-transmitter to rotate.

In some embodiments, an electric fireplace includes a fireplace cabinet, a window provided in the front side of the fireplace cabinet which connects the inner cavity of the fireplace cabinet, and a flame simulating device provided in the inner cavity of the fireplace cabinet.

### BRIEF DESCRIPTION

Some of the embodiments will be described in detail, with reference to the following figures, wherein like designations denote like members, wherein:

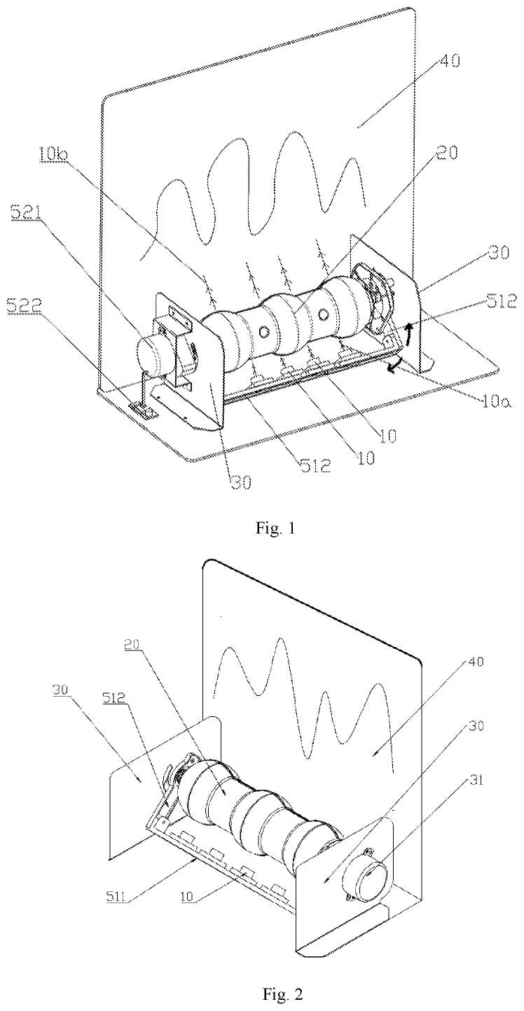

FIG. 1 is an overall structure view of the flame simulating device in some embodiments;

FIG. 2 is a side view of the structure of the flame simulating device in some embodiments;

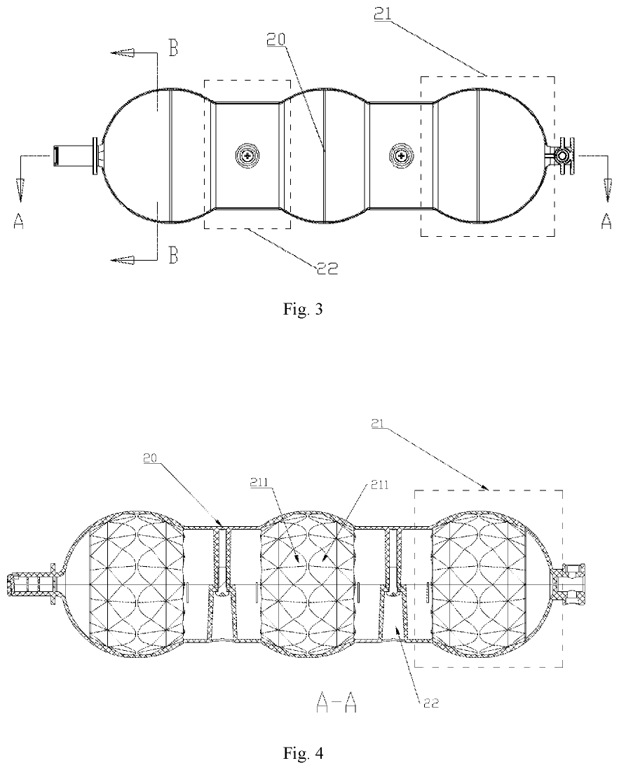

FIG. 3 is a structural diagram of the light-transmitter in some embodiments;

FIG. 4 is an A-A sectional view of the light-transmitter in some embodiments;

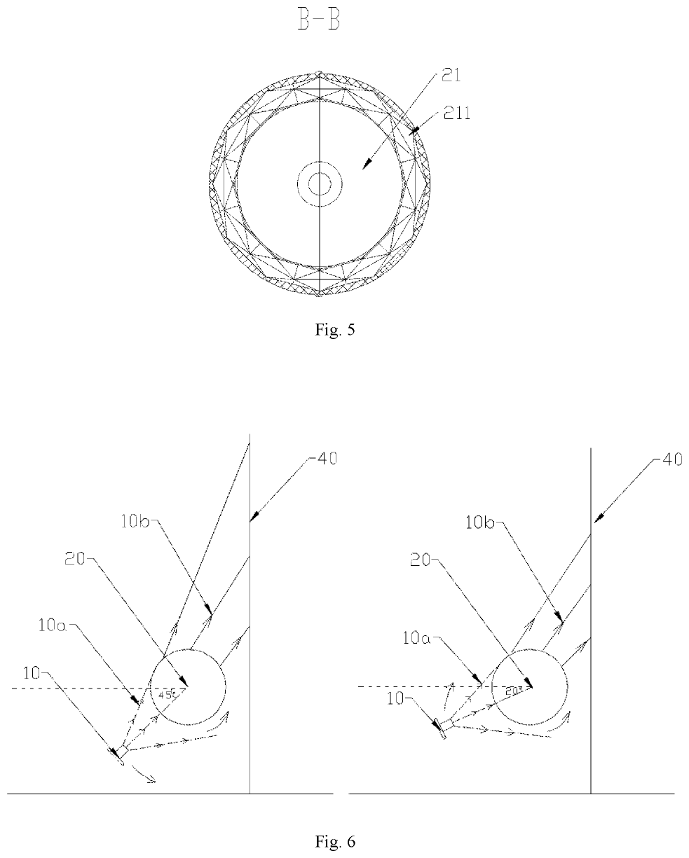

FIG. 5 is a B-B sectional view of the light-transmitter in some embodiments; and

FIG. 6 is a schematic diagram of the flame height adjustment in some embodiments.

### REFERENCE NUMERALS IN THE FIGURES

10-light source, 10a-first light group, 10b-second light group, 20-light-transmitter, 21-sub light-transmitter, 22-connecting component, 211-light-mixing block, 30-support frame, 31-motor, 40-imaging plate, 511-base shelf, 512-connecting bridge, 521-driving motor, 521a-connecting block, 522-swing controller.

### DETAIL DESCRIPTION

For a better understanding and implementation, embodiments of the present invention will be described in detail below in combination with accompanying drawings.

Please refer to FIGS. 1-4, in some embodiments, an electric fireplace includes a cabinet, an simulated fuel (not shown) and a flame simulating device provided in the cabinet, wherein the front side face of the cabinet is provided with a window, which connects the inner cavity of the cabinet, and the flame simulating device is disposed in the inner cavity of the cabinet.

The simulated fuel is disposed near the window, and the simulated fuel can be seen when looking from the window to the inner cavity of the cabinet. In some embodiments, the simulated fuel includes simulated embers and simulated charcoal, a plurality of simulated charcoal stacked on the simulated embers pile, and the plurality simulated charcoal inclined toward the inner cavity. The simulated charcoal is made of light-transmitting resin and is grayish black. In some embodiments, a simulated fuel light source (not shown) for illuminating the simulated fuel is disposed below the simulated fuel. In some embodiments, the simulated fuel light source is an LED lamp, and the LED lamp is orange-red or orange-yellow.

The flame simulating device includes a light source 10, a light-transmitter 20, an imaging plate 40 and a swing unit. The light source 10 emits a first light group 10a; the first light group 10a is projected to the light-transmitter 20 to form a second light group 10b, and the second light group 10b is projected on the imaging plate 40 to form an image. The light source 10 is disposed on the swing unit, the swing unit drives the light source 10 to move relatively around the light-transmitter, the swing unit changes the angle that the first light group emitted to the light-transmitter, thus to make the image projected on the image plate formed by the second light group move, increase or decrease.

In some embodiments, the light source 10 is an LED light source 10, which includes at least one row of LED arrays arranged at equal intervals by a number of LED luminous chips. The LED arrays are arranged parallel to the axial direction of the light-transmitter and are directly opposite to the light-transmitter. Each of the LED arrays includes at least a blue LED light and an orange-red LED light.

In some embodiments, the light-transmitter 20 is a symmetrical or asymmetric structure, and in some embodiments, the light-transmitter 20 is a solid or hollow structure. In some embodiments, the light-transmitter 20 is a sphere, a cylinder, or a rotary body formed by taking an arched arc as a generatrix, and taking a line at both ends of the arc or a line parallel to the line as an axis. In some embodiments, the light-transmitter 20 is provided with a number of light-mixing blocks 211 which are convex lenses or concave lenses, or a combination of both. When the sub light-transmitter 21 is hollow, the light-mixing blocks 211 are disposed on its outer wall and/or an inner wall. When the light-transmitter 21 is solid, the light-mixing blocks 211 are disposed on its outer surface. The light emitted by the light source 10 creates a mixing effect of reflection, refraction, concentration, and astigmatism between these convex lenses, concave lenses, or a combination thereof.

In some embodiments, the light-transmitter 20 includes at least three sub light-transmitters 21. These sub light-transmitters 21 are coaxially arranged and connected through a connecting component 22. Referring to FIGS. 5-7, each of the sub light-transmitters 21 is a hollow sphere, or a rotary body formed by rotating an arched arc as a generatrix around a line formed by the two ends of the arc or a line parallel to this line as an axis. The light-mixing blocks 211 are disposed on the inner surface of the sub light-transmitter. The light-mixing blocks 211 are closely arranged along a circumferential direction of the sub light-transmitter 21 to form a light-mixing block circle, and a number of light-mixing block circles are arranged along an axial direction of the sub light-transmitter 21. In some embodiments, the connecting component 22 may be transparent or opaque. In some embodiments, the connecting component 22 is a cylinder with a diameter slightly smaller than the hollow sphere, and the surface of the connecting component 22 is provided with a frosted surface to form an opaque structure, and reduce the mutual interference between the light passing through each sub light-transmitter 21.

The light-transmitter 20 is arranged on the bottom plate (not shown) of the cabinet through a support frame 30. In some embodiments, the rotary axle shaft of the light-transmitter 20 is hinged and threaded on the support frame 30, and the light-transmitter 20 is driven to rotate by a motor 31. The light-mixing blocks make light reflect, refract, condense, and diverge between the convex lenses, the concave lenses, or a combination of the two, thus forming the light mixing effect.

In some embodiments, the imaging plate 40 is a rear shell plate of the cabinet, and a wallpaper with a brick pattern is pasted thereon. In some embodiments, the imaging plate 40 is a transparent plate disposed in the middle of the cabinet, in some embodiments, the imaging plate 40 is a translucent plate made from hard transparent plastic with excellent optical properties.

The swing unit includes a swing shelf and a driving component. The driving component drives the swing shelf to move around the light-transmitter. In some embodiments, the driving component drives the swing shelf to swing about the rotary axle of the light-transmitter. In some embodiments, the swing shelf includes a base shelf 511 and a connecting bridge 512; one end of the connecting bridge 512 is fixed to the base shelf 511, and the other end is connected to the light-transmitter. In some embodiments, the base shelf 511 is a strip plate which is parallel to the rotary axle of the light-transmitter; the light sources 10 are arranged on the base frame 511 and arranged at equal intervals in the length direction of the strip plate. In some embodiments, the length of the base shelf 511 is similar to or equal to the length of the light-transmitter. In some embodiments, there are two connecting bridges 512 provided at two ends of the base shelf 511, one end of each connecting bridge 512 is fixed to the base shelf 511, and the other end is sleeved on the rotary shaft of the light-transmitter 20 and is hinged on the support frame 30, so that the swing shelf can drive the light source 10 to swing around the rotary axle of the light-transmitter 20.

The driving component includes a driving motor 521 and a swing controller 522. In some embodiments, a driving shaft of the driving motor 521 is fixed to the connecting bridge 512 through a connecting block 521a, and the driving motor 521 drives the swing shelf to swing back and forth around the light-transmitter 20. In some embodiments, the driving motor 521 is disposed on the support frame 30. In some embodiments, the swing controller 522 controls the rotary mode of the driving motor 521. In some embodiments, the rotary speed of the driving motor and the switch frequency of the forward and reverse movements of its driving shaft are preset in the swing controller 522, so as to control the driving motor 521 to rotate in the forward direction for a certain period of time and then rotate in the reverse direction, thereby driving the connecting bridge 512, the base shelf 511, and the light source 10 to swing back and forth around the light-transmitter.

Next the theory of height adjustment of the simulated flame on the imaging plate 40 will be described. During the relative movement of the light source 10 around the light-transmitter, the incident angle of the first light group 10a emitted by the light source 10 into the light-transmitter will change. Therefore, the exit angle of the light group 10b also changes, and then images are formed in different height ranges on the imaging plate 40, and flames of different sizes are simulated. Further, since the light source 10 is rotated with the driving motor 521, the incident angle of the first light group 10a entering the light-transmitter is continuously changed, so the exit angle of the second light group 10b is also continuously changed. Therefore, on the imaging plate 40, a combustion effect of the flame which is sometimes large and sometimes small is exhibited. In some embodiments, in order to facilitate the explanation of the theory, the incident angle is defined herein as the included angle between the line, which connects the light source 10 and the center of the light-transmitter, and the horizontal plane, and the incident angle of the light source 10 is assumed to vary between 45° and 20° . Please refer to FIG. 6, in the initial state, when the incident angle of the light source 10 is 45° , the incident angle of the first light group 10a entering the light-transmitter is the largest, and at this time, the “flame area” formed by the formed second light group 10b irradiating on the imaging plate 40 is the largest, with the overall effect that the height of the flame presented on the imaging plate 40 is the highest, covering almost the entire imaging plate 40; when the driving motor 521 rotates, the incident angle of the light source 10 decreases gradually, and the “flame area” formed by the formed second light group 10b on the imaging plate 40 gradually becomes smaller, with the overall effect that the height of the flame presented on the imaging plate 40 gradually decreases; when the incident angle of the light source 10 is 20° , the incident angle of the first light group 10a entering the light-transmitter is the smallest, and the “flame area” formed by the formed second light group 10b on the imaging plate 40 is the smallest, with the overall effect that the height of the flame presented on the imaging plate 40 is the shortest. The above incident angle is defined as 45°-20° only as a theoretical explanation. In some embodiments, the incident angle can be adjusted according to the distance between the light source 10 and the light-transmitter 20, the height of the imaging plate 40 and other factors, so as to obtain the best effect for simulating a flame.

When in use, the first light group emitted by the light source after powered on is projected into the rotary light-transmitter, it passes through the light-transmitter and the light-mixing blocks disposed on the light-transmitter to generate multiple times of reflection, refraction, concentration and astigmatism, and then a second light group is formed and projected onto the imaging plate to achieve light spots of different brightness and darkness. As the surface of the light-transmitter with an arc structure, and the position of each light-mixing block on the light-transmitter is different, and the distance from the light-mixing block to the imaging plate is also different, so after light passes through different light-mixing blocks, the size, shape, brightness, and position of the light spots formed on the imaging plate are different, and with the rotating of the light-transmitter, the mixed light on the imaging plate shows the effects of the flickering flames and the jumping flames. Meanwhile, the light source swings back and forth with the driving motor around the light-transmitter, so that the incident angle of the first light group entering the light-transmitter is constantly changed, and the exit angle is also constantly changed, the range of the images formed by the second light group projected on the imaging plate is different with an overall result of different flame heights on the imaging plate, thus the effect of adjusting the size of simulated flame is achieved. In addition, since the driving motor can switch the rotary mode under the control of the swing controller, the flame simulating device can not only simulate the combustion effect of gradually increasing flame from small to large, but also simulate the continuous dynamic effect of the flame sometimes large and sometimes small, which improves the realism and three-dimensionality of the combustion simulation of the simulated fuel.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality.

What is claimed:

1. A flame simulating device, wherein the flame simulating device comprises a light source, a rotary light-transmitter, an imaging plate, a swing shelf and a driving component; the light source emits a first light group; the first light group is projected to the light-transmitter to form a second light group; the light source is disposed on the swing shelf, and the driving component drives the swing shelf to swing around the light-transmitter.

2. The flame simulating device of claim 1, wherein the driving component comprises a driving motor, the swing shelf comprises a base shelf and a connecting bridge, and the light source is disposed on the base shelf; one end of the connecting bridge is fixed to the base shelf, and another end is fixed to the driving shaft of the driving motor; the driving motor drives the base shelf to swing around the light-transmitter via the connecting bridge.

3. The flame simulating device of claim 2, wherein the driving component comprises a swing controller, and the swing controller controls the rotary mode of the driving motor.

4. The flame simulating device of claim 3, wherein the base shelf is a strip plate which is parallel to the rotary axle of the light-transmitter.

5. The flame simulating device of claim 4, wherein the light-transmitter is provided with a plurality of light-mixing blocks, and the first light group is projected into the light-transmitter and the light-mixing blocks thereof to form a second light group.

6. The flame simulating device of claim 5, wherein the light-mixing blocks are selected from the group consisting of convex lenses, concave lenses and a combination of convex lenses and concave lenses.

7. The flame simulating device of claim 6, wherein the light-transmitter comprises at least two sub light-transmitting bodies connected through a connecting component, each sub light-transmitter is a rotary body formed by rotating an arch arc around an axis; the light-mixing blocks are arranged along the circumferential direction of the light-transmitter to form a light-mixing block circle, and a number of light-mixing block circles are arranged along an axial direction of the light-transmitter.

8. The flame simulating device of claim 7, wherein the flame simulating device comprises a motor, and the motor drives the light-transmitter to rotate.

9. The flame simulating device of claim 8, wherein the sub light-transmitter is hollow, and the disposing position of the light-mixing block is selected from the group consisting of an outer wall of the light-transmitter, an inner wall of the light-transmitter and a combination of the outer wall and the inner wall.

10. The flame simulating device of claim 8, wherein the light-transmitter is solid, and the light-mixing block is disposed on an outer surface of the light-transmitter.

11. An electric fireplace comprising a fireplace cabinet and a window provided in the front side of the fireplace cabinet which connects the inner cavity of the fireplace cabinet, wherein the flame simulating device of claim 1 is provided in the inner cavity of the fireplace cabinet.

12. The electric fireplace of claim 11, wherein the driving component comprises a driving motor, the swing shelf comprises a base shelf and a connecting bridge, and the light source is disposed on the base shelf; one end of the connecting bridge is fixed to the base shelf, and another end is fixed to the driving shaft of the driving motor; the driving motor drives the base shelf to swing around the light-transmitter via the connecting bridge.

13. The electric fireplace of claim 12, wherein the driving component comprises a swing controller, and the swing controller controls the rotary mode of the driving motor.

14. The electric fireplace of claim 13, wherein the base shelf is a strip plate which is parallel to the rotary axle of the light-transmitter.

15. The electric fireplace of claim 14, wherein the light-transmitter is provided with a plurality of light-mixing blocks, and the first light group is projected into the light-transmitter and the light-mixing blocks thereof to form a second light group.

16. The electric fireplace of claim 15, wherein the light-mixing blocks are selected from the group consisting of convex lenses, concave lenses and a combination of convex lenses and concave lenses.

17. The electric fireplace of claim 16, wherein the light-transmitter comprises at least two sub light-transmitting bodies connected through a connecting component, each sub light-transmitter is a rotary body formed by rotating an arch arc around an axis; the light-mixing blocks are arranged along the circumferential direction of the light-transmitter to form a light-mixing block circle, and a number of light-mixing block circles are arranged along an axial direction of the light-transmitter.

18. The electric fireplace of claim 17, wherein the flame simulating device comprises a motor, and the motor drives the light-transmitter to rotate.

19. The electric fireplace of claim 18, wherein the sub light-transmitter is hollow, and the disposing position of the light-mixing block is selected from the group consisting of an outer wall of the light-transmitter, an inner wall of the light-transmitter and a combination of the outer wall and the inner wall.

20. The electric fireplace of claim 18, wherein the light-transmitter is solid, and the light-mixing block is disposed on an outer surface of the light-transmitter.
